(19) United States
(12) Patent Application Publication
(10) Pub. No.: US 2007/0232713 A1
(43) Pub. Date: Oct. 4, 2007

(54) Radiation Curable Liquid Resin Composition for Optical Three-Dimensional Molding and Optical Molded Article Obtained by Photocuring Same

(75) Inventors: Katsuyuki Takase, Tokyo (JP); Ryouji Tatara, Tokyo (JP); Masanobu Sugimoto, Tokyo (JP); Zen Komiya, Tokyo (JP)

Correspondence Address: NIXON & VANDERHYE, PC, 901 NORTH GLEBE ROAD, 11TH FLOOR, ARLINGTON, VA, 22203, US

(73) Assignees: JSR Corporation, Tokyo (JP); Japan Fine Coatings Co., Ltd., Ibaraki (JP); DSM IP Assets B.V., Te Heerlen (NL)

(21) Appl. No.: 11/596,744

(22) PCT Filed: May 26, 2005
(86) PCT No.: PCT/JP05/09645

§ 371 Date: Jun. 4, 2007

(30) Foreign Application Priority Data
May 26, 2004 (JP) 2004-156251

(51) Int. Cl. C08G 59/18; B29C 67/00; C08K 5/13; C08K 5/524; C08L 63/00

(52) U.S. Cl. 522/6

(57) ABSTRACT

Provided is a radiation curing liquid resin composition for optical three-dimensional modeling, which has a small step on the side face and excellent surface smoothness, and allows forming a high accuracy optically modeled article, is composed of the components (A) through (F). The content of (A) component in the total quantity of the composition is 0.1 to 10% by mass, and the content of (F) polyether polyol compound is 1 to 35% by mass. (A) A compound having phenolic hydroxyl group and/or phosphite group, (B) A cationic polymerizable compound, (C) A cationic polymerization initiator, (D) A radical polymerizable compound, (E) A radical polymerization initiator, and (F) A polyether polyol compound.

### TECHNICAL FIELD

The present invention relates to a radiation curing liquid resin composition for optical three-dimensional modeling and an optically modeled article obtained by optically curing the composition.

### BACKGROUND ART

There is a known optical three-dimensional modeling method to form a three-dimensional shape object having a structure of an integrally laminated cured resin layer, being formed by repeating the step of forming the cured resin layer through the selective irradiation of light to a radiation curing liquid substance (a liquid resin composition), (JP-A-60-247515, JP-A-62-35966, JP-A-62-101408, and JP-A-5-24119, (the term “JP-A” referred to herein signifies the “Unexamined Japanese Patent Publication”)). According to the typical optical three-dimensional modeling method, a cured resin layer having a specified pattern is formed by the steps of: selectively irradiating light such as ultraviolet laser to the liquid surface of a radiation curing liquid resin composition which is held in a container; supplying a radiation curing liquid resin composition in a quantity of a single layer thereof onto the cured resin layer; selectively irradiating light onto the liquid surface, thus integrally laminating a new cured resin layer onto the precedently formed cured resin layer in a continuing configuration with each other; and repeating the above steps for a specified number of cycles with or without varying the light-irradiation pattern, thus forming a three-dimensional shape object having integrally laminated a plurality of cured resin layers. The optical three-dimensional modeling method provides a complex shape of the target three-dimensional shape object easily within a short time. The technology is extremely useful in a process of prototype-fabrication for the development of new products in the automobile industry and the household electric appliance industry, and has been becoming an essential means for shortening the development period and for reducing cost.

Known radiation curing liquid resin compositions used in the optical three-dimensional modeling method include the resin compositions represented by [1] to [3]: [1] a resin composition containing radical polymerizable organic compound such as urethane(meth)acrylate, oligoester(meth)acrylate, epoxy(meth)acrylate, thiol, en compound, and photosensitive polyimide, (refer to JP-A-1-204915, JP-A-2-208305, and JP-A-3-160013); [2] a resin composition containing cationic polymerizable organic compound such as epoxy compound, cyclic ether compound, cyclic lactone compound, cyclic acetal compound, cyclic thioether compound, spiro-ortho-ester compound, and vinylether compound, (refer to JP-A-1-213304); and [3] a resin composition containing radical polymerizable organic compound and cationic polymerizable organic compound, (refer to JP-A-2-28261, JP-A-2-75618, JP-A-6-228413, JP-A-11-310626, JP-A-11-228610, and JP-A-11-240939).

Three-dimensional shape objects obtained from those three-dimensional modeling methods have been widely used in the past as the shape-confirmation models for investigating the design. Recent market trend, however, tends to emphasize further high three-dimensional modeling accuracy, in particular the improvement in the surface smoothness caused by the side-face step appearing between the respective lamination layers on the modeled article.

The composition of [1] is, however, very difficult to attain high modeling accuracy owing to the large curing shrinkage. Although the composition of [2] provides high modeling accuracy, it tends to provide a cured article of low toughness and high brittleness. Furthermore, the composition of [2] is inferior in the initial strength (green strength) after photo-curing and in the curing rate to the composition of [1], thus difficult to attain high modeling rate. The composition of [3] attains high modeling accuracy and excellent mechanical characteristics compensating the drawbacks of above two methods. Compared with general-use resins, however, the composition of [3] is inferior in a part of mechanical and thermal characteristics, and in particular, has a problem of inferiority in breaking toughness to the general-use resins.

On the other hand, the improvement in the three-dimensional modeling accuracy needs to decrease the dimensional deformation after the photo-curing. Accordingly, increase in the initial strength (green strength) after photo-curing needs to increase the radiation curing property. Nevertheless, a radiation curing liquid resin composition having high photo-curing rate almost completes the curing reaction within a short time after irradiating light, or has a small contribution of the delayed curing reaction so that a step on the side face between the respective laminated layers often appears. As a result, sufficient smoothness is difficult to attain on the surface of the optically modeled article, in particular on the side face thereof.

Although JP-A-8-256062 and JP-A-2003-73457 describe an antioxidant as a component which is able to be added to the radiation curing liquid resin composition used in the optical three-dimensional modeling method, they did not describe the modeling accuracy of the optically modeled article, particularly the relation with the step on the side face of the article.

An object of the present invention is to provide a radiation curing liquid resin composition for optical three-dimensional modeling, which composition allows forming a highly accurate optically modeled article having small step on the side face and excellent surface smoothness.

### DISCLOSURE OF THE INVENTION

The present invention provides the following-described radiation curing liquid resin composition for optical three-dimensional modeling and the optically modeled article.

1. A radiation curing liquid resin composition for optical three-dimensional modeling, having the components (A) through (F), the content of (A) component in the total quantity of the composition being 0.1 to 10% by mass, and the content of (F) polyether polyol compound being 1 to 35% by mass:

(A) a compound having phenolic hydroxyl group and/or phosphite group,

(B) a cationic polymerizable compound,

(C) a cationic polymerization initiator,

(D) a radical polymerizable compound,

(E) a radical polymerization initiator, and

(F) a polyether polyol compound.

2. The radiation curing liquid resin composition for optical three-dimensional modeling according to above 1, wherein the content of each of (B) component through (E) component in the total quantity of the composition is:

15 to 85% by mass of (B) the cationic polymerizable compound,

0.1 to 10% by mass of (C) the cationic polymerization initiator,

0.1 to 25% by mass of (D) the radical polymerizable compound, and

0.01 to 10% by mass of (E) the radical polymerization initiator.

3. The radiation curing liquid resin composition for optical three-dimensional modeling according to above 1 or 2, further having (G) elastomer particles having a number-average particle size determined by the electron microscope method in a range from 10 to 1000 nm in a quantity of 1 to 35% by mass to the total quantity of the composition.

4. The radiation curing liquid resin composition for optical three-dimensional modeling according to any of above 1 to 3, wherein (A) the compound having phenolic hydroxyl group and/or phosphite group is at least one compound selected from the group consisting of compounds represented by the formula (1), the formula (2), and the formula (3): 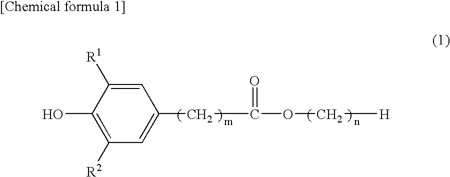
where R¹ and R² are each independently C1 to C4 alkyl group which may have a branched structure, and m and n are each independently 1 or 2; 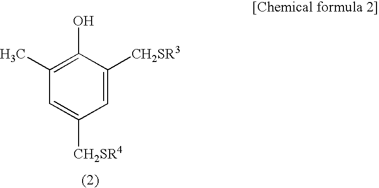
where R³ and R⁴ are each independently C6 to C₁₀ alkyl group which may have a branched structure; and 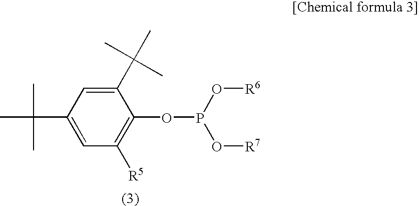
where R⁵ is a hydrogen or a methyl group, R⁶ and R⁷ are each independently an organic group, and R⁶ and R⁷ may bond together to form a cyclic structure.

5. An optically modeled article being manufactured by irradiating light to the radiation curing liquid resin composition for optical three-dimensional modeling according to any one of above 1 to 4.

The radiation curing liquid resin composition for optical three-dimensional modeling according to the present invention, (hereinafter referred to as the “composition of the present invention”), has advantages of small step on the side face, excellent surface smoothness, and allowing forming a high accuracy optically modeled article.

### BEST MODES FOR CARRYING OUT THE INVENTION

The present invention is described in detail in the following.

I. Radiation Curing Liquid Resin Composition for Optical Three-Dimensional Modeling

The radiation curing liquid resin composition for optical three-dimensional modeling according to the present invention, (hereinafter referred to as the “composition of the present invention”), contains the above components (A) through (F) as the essential structural components. The following description is for the respective essential components (A) through (F) and for an arbitrary component (G), and the like.

The (A) Component

The (A) component used in the composition of the present invention is a compound having phenolic hydroxide group and/or phosphite group. Applicable (A) component includes a known antioxidant, and specifically preferred ones are hindered phenol-based compound and phosphorus-based compound. With the addition of the (A) component, the curing of radical polymerizable compound is subjected to a certain hindrance, which allows gradual polymerization of cationic polymerizable compound and the like, (delayed curing property), even after the light irradiation, thus decreasing the step of the laminated layers on the side face of the modeled article.

Examples of the (A) component are the following compounds. The hindered phenolic compound includes, pentaerythrityl-tetrakis[3-(3,5-di-t-butyl-4-hydroxyphenyl)propionate] (Irganox 1010), thiodiethylene-bis[3-(3,5-di-t-butyl-4-hydroxyphenyl)propionate] (Irganox 1035FF), 3,5-bis(1,1-dimethylethyl)-4-hydroxy-benzene propanate, ethylenebis(oxyethylene)bis[3-(5-tert-butyl-4-hydroxy-m-tolyl)propionate] (Irganox 245), octadecyl-3-(3,5-t-butyl-4-hydroxyphenyl)propionate (Irganox 1076), 3,3′,3″,5,5′,5″-hexa-t-butyl-a,a′,a″-(mesitylene-2,4,6-triyl)tri-p-cresol (Irganox 1330), 1,3,5-tris(3,5-di-t-butyl-4-hydroxybenzyl)-1,3,5-triazine-2,4,6(1H,3H,5H)trione (Irganox 3114), 4,6-bis(octylthiomethyl)-o-cresol (Irganox 1520L), 9-bis[2-{3-(3-tert-butyl-4-hydroxy-5-methylphenyl)propionyloxy}-1,1-dimethylethyl]-2,4,8,10-tetraoxaspiro[5,5]undecane (Sumilizer GA-80), and 2,6-t-butyl-4-methylphenol (Sumilizer BHT): (Irganox is a trade mark of Ciba Specialty Chemicals K.K., and Sumilizer is a trade mark of Sumitomo Chemical Co., Ltd.).

The phosphorus-based compound includes tris(2,4-di-t-butylphenyl)phosphite (Irgafos 168), bis[2,4-bis(1,1-dimethylethyl)-6-methylphenyl]ethyl phosphite (Irgafos 38), and 6-[3-(3-t-butyl-4-hydroxy-5-methylphenyl)-propoxy]-2,4,8,10-tetra-t-butylbenz[d,f][1,3,2]-dioxaphosphepin (Sumilizer GP): (Irgafos is a trade mark of Ciba Specialty Chemicals K.K., and Sumilizer is a trade mark of Sumitomo Chemical Co. Ltd.).

Examples of the commercially available hindered phenol-based (A) component are Irganox 1010, 1035FF, 245, 1076, 1330, 3114, 1520L, and 3125, (manufactured by Ciba Specialty Chemicals K.K.), Sumilizer BHT, and GA-80, (manufactured by Sumitomo Chemical Co., Ltd.), and Cyanox 1790 (manufactured by Cytec Co., Ltd.).

Examples of the commercially available phosphorus-based (A) component are Irgafos 168, 12, and 38, (manufactured by Ciba Specialty Chemicals K.K.), ADK, STAB, 329K, PEP36, and PEP-8, (manufactured by ADECA Corporation), Sandstab P-EPQ (manufactured by Clariant Inc.), Weston 618, 619G, and Ultranox 626, (manufactured by General Electric Company), and Sumilizer GP (manufactured by Sumitomo Chemical Co., Ltd.).

Of the above-given (A) components, preferred ones because of excellent delayed curing property are, pentaerythrityl-tetrakis[3-(3,5-di-t-butyl-4-hydroxyphenyl)propionate], 3,5-bis(1,1-dimethylethyl)-4-hydroxy-benzene propanate, ethylenebis(oxyethylene)bis[3-(5-tert-butyl-4-hydroxy-m-tolyl)propionate], 4,6-bis(octylthiomethyl)-o-cresol, bis[2,4-bis(1,1-dimethylethyl)-6-methylphenyl]ethylphosphite, and 6-[3-(3-t-butyl-4-hydroxy-5-methylphenyl)-propoxy]-2,4,8,10-tetra-t-butylbenz[d,f][1,3,2]-dioxaphosphepin.

Specifically preferred (A) compound in the composition of the present invention is one or more compounds selected from the group consisting of compounds represented by the formula (1), the formula (2), and the formula (3) given below. 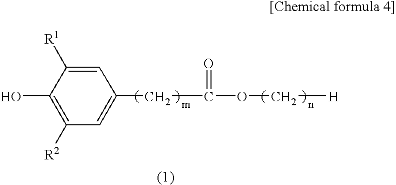
where R¹ and R² are each independently C1 to C4 alkyl group which may have a branched structure, and m and n are each independently 1 or 2.

Examples of commercially available compound having the structure represented by the formula (1) are above-described Irganox 1010, 1035, and 245, and Sumilizer GA-80. 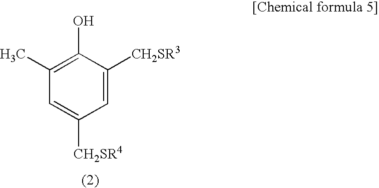
where R³ and R⁴ are each independently C6 to C10 alkyl group which may have a branched structure.

Commercially available compound having the structure represented by the formula (2) is, for example, Irganox 1520L. 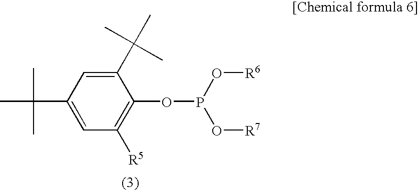
where R⁵ is a hydrogen or a methyl group, R⁶ and R⁷ are each independently an organic group, and R⁶ and R⁷ may bond together to form a cyclic structure.

Examples of commercially available compound having the structure represented by the formula (3) are Irganox 38 and Sumilizer GP.

The content of (A) component in the composition of the present invention is normally in a range from 0.1 to 10% by mass to the total quantity of the composition, preferably from 0.1 to 5% by mass, and more preferably from 1.0 to 5.0% by mass.

The (B) Component

The (B) component used in the composition of the present invention is a cationic polymerizable compound, and is a compound that initiates polymerization reaction and crosslinking reaction under irradiation of light in the presence of a cationic photo-polymerization initiator.

Although the (B) cationic polymerizable compound is not specifically limited, a preferable one is a compound having two or more alicyclic epoxy groups in a single molecule. With the presence of 50% by mass or more of the compound having two or more alicyclic epoxy groups in a single molecule to the total quantity of (B) component, good curing rate and mechanical strength are maintained.

Examples of the (B) cationic polymerizable compound are: bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolak resin, hydrogenated bisphenol A diglycidyl ether, hydrogenated bisphenol F diglycidyl ether, hydrogenated bisphenol S diglycidyl ether, 3,4-epoxy cyclohexyl methyl-3′,4′-epoxycyclohexylcarboxylate, 2-(3,4-epoxycyclohexyl-5,5-spiro-3,4-epoxy)cyclohexane-metha-dioxane, bis(3,4-epoxycyclohexylmethyl)adipate, bis(3,4-epoxy-6-methylcyclohexylmethyl)adipate, 3,4-epoxy-6-methylcyclohexyl-3′,4′-epoxy-6′-methylcyclohexane carboxylate, ε-caprolactone modified 3,4-epoxycyclohexylmethyl-3′,4′-epoxycyclohexane carboxylate, trimethylcaprolactone modified 3,4-epoxycylohexylmethyl-3′,4′-epoxycyclohexane carboxylate, β-methyl-δ-valerolactone modified 3,4-epoxycyclohexylmethyl-3′,4′-epoxycyclohexane carboxylate, methylenebis(3,4-epoxycyclohexane), di(3,4-epoxycyclohexylmethyl)ether of ethyleneglycol, ethylenebis(3,4-epoxycyclohexane carboxylate), epoxycyclohexadioctyl hydrophthalate, epoxycyclohexa-di-2-ethylhexyl hydrophthalate, 1,4-butanediol diglycidylether, 1,6-hexanediol diglycidylether, neopentylglycol diglycidylether, trimethylolpropane triglycidylether, polyethyleneglycol digrycidylether, glycerin triglycidylether, and polypropyleneglycol diglycidylether; polyglycidylether of polyether polyol prepared by adding one or more alkylene oxide to aliphatic polyhydric alcohol such as ethyleneglycol, propyleneglycol, and glycerin; diglycidylester of long chain aliphatic dibasic acid; monoglycidylether of higher aliphatic alcohol; monoglycidylether of polyether alcohol prepared by adding phenol, cresol, butylphenol, or alkyleneoxide; grycidylester of higher fatty acid; epoxylated soybean oil; epoxybutylstearate; epoxyoctylstearate; epoxylated linseed oil; and epoxylated polybutadiene. The above cationic polymerizable compounds can structure the (B) component separately or in combination of two or more of them.

Of these cationic polymerizable compounds, preferred ones are 3,4-epoxycyclohexylmethyl-3′,4′-epoxycyclohexyl carboxylate, bis(3,4-epoxycyclohexylmethyl)adipate, ε-caprolactone modified 3,4-epoxycyclohexylmethyl-3′,4′-epoxycyclohexyl carboxylate, trimethylcaprolactone modified 3,4-epoxycyclohexylmethyl-3′,4′-epoxycyclohexane carboxylate, β-methyl-δ-valerolactone modified 3,4-epoxycyclohexylmethyl-3′,4′-epoxycyclohexane carboxylate, bisphenol A diglycidyl ether, bisphenol F diglycidyl ether, hydrogenated bisphenol A diglycidyl ether, hydrogenated bisphenol F diglycidyl ether, 1,4-butanediol diglycidylether, 1,6-hexanediol diglycidylether, trimethylolpropane triglycidylether, glycerin triglycidylether, polyethyleneglycol digrycidylether, and polypropyleneglycol diglycidylether.

More preferred ones are compounds having two or more alicyclic epoxy groups in a single molecule, such as 3,4-epoxycyclohexylmethyl-3′,4′-epoxycylcohexyl carboxylate and bis(3,4-epoxycyclohexylmethyl)adipate. To maintain good curing rate and mechanical strength, the epoxy compound preferably exists at 50% by mass or more in the (B) component.

Examples of commercially available (B) cationic polymerizable compound are UVR-6100, UVR-6105, UVR-6110, UVR-6128, UVR-6200, and UVR-6216, (manufactured by Union Carbide Corporation), CELOXIDE 2021, CELOXIDE 2021P, CELOXIDE 2081, CELOXIDE 2083, CELOXIDE 2085, Epolead GT-300, Epolead GT-301, Epolead GT-302, Epolead GT-400, Epolead 401, and Epolead 403, (manufactured by DAICEL CHEMICAL INDUSTRIES, LTD.), KRM-2100, KRM-2110, KRM-2199, KRM-2400, KRM-2410, KRM-2408, KRM-2490, KRM-2200, KRM-2720, and KRM-2750, (manufactured by ADECA Corporation), Rapi-cure DVE-3, CHVE, PEPC, (manufactured by ISP Co., Ltd.), Epicoat 828, Epicoat 812, Epicoat 1031, Epicoat 872, and Epicoat CT508, (manufactured by Japan Epoxy Resin Co., Ltd.), XDO (manufactured by TOA GOSEI CO., TTD.), and VECOMER 2010, 2020, 4010, and 4020, (manufactured by Allied Signal, Inc.).

The content of (B) component in the composition of the present invention is normally in a range from 15 to 85% by mass to the total quantity of the composition. However, the content thereof is preferably in a range from 30 to 80% by mass, and more preferably from 40 to 75% by mass. If the content of (B) component exceeds 85% by mass, the deformation of optically modeled article, such as warp, likely increases. If the content thereof is less than 15% by mass, satisfactory mechanical and thermal characteristics of the optically modeled article likely cannot be attained.

The (C) Component

The (C) component used in the composition of the present invention is a cationic polymerization initiator, and is a compound that can initiate the cationic polymerization of the (B) component under radiation. The term “radiation” referred to herein signifies visible light, ultraviolet light, infrared light, electron beam, X-ray, a ray, P ray, y ray, and the like.

Examples of the (C) cationic polymerization initiator are compounds represented by the following general formula (4).
[R⁸ₐR⁹_{b}R¹⁰_{c}R¹¹_{d}W]^{+p}[MX_{p+q}]^{-q} (4)

where: the cation is onium ion; W is S, Se, Te, P, As, Sb, Bi, 0, I, Br, Cl, or N═N; R⁸, R⁹, R¹⁰, and R¹¹ are each the same or different organic group; a, b, c, and d are each an integer of 0 to 3, and (a+b+c+d) is equal to the valence number of W; M is a metal or a metalloid of the core atom of halogenated complex [MX_{p+q}], for example, B, P, As, Sb, Fe, Sn, Bi, Al, Ca, In, Ti, Zn, Sc, V, Cr, Mn, and Co; X is a halogen atom such as F, Cl, and Br; q is a net charge of the complex ion of halogenated compound; and p is the valence of M. The onium salt is a compound that emits Lewis acid under irradiation of light. Examples of anion [MX_{p+q}]^{-q} in the above general formula (4) are tetrafluoroborate (BF₄⁻), hexafluorophosphate (PF₆⁻), hexafluoroantimonate (SbF₆⁻), hexafluoroarsenate (AsF₆⁻), and hexachloroantimonate (SbCl₆⁻).

Examples of commercially available (C) cationic polymerization initiator are UVI-6950, UVI-6970, UVI-6974, and UVI-6990, (manufactured by Union Carbide Corporation), Adeca Optomer SP-150, SP-151, SP-170, and SP-172, (manufactured by ADECA CORPORATION), Irgacure 261 (manufactured by Ciba Specialty Chemicals K.K.), CI-2481, CI-2624, CI-2639, and CI-2064, (manufactured by NIPPON SODA CO., LTD.), CD-1010, CD-1011, and CD-1012, (manufactured by Sartomer Company, Inc.), DTS-102, DTS-103, NAT-103, NDS-103, TPS-103, MDS-103, MPI-103, and BBI-103, (manufactured by Midori Kagaku Co., Ltd.), PCI-061T, PCI-062T, PCI-020T, and PCI-022T, (manufactured by NIPPON KAYAKU CO., LTD.), CPI-110A (manufactured by SAN-APRO LIMITED), and CPI-6976 (manufactured by Aceto Corporation). Of these, UVI-6970, UVI-6974, Adeca Optomer SP-170, SP-172, CD-1012, MPI-103, and CPI-110A are specifically preferred because they provide the resin composition containing them with high photo-curing sensitivity. The above-given cationic photo-polymerization initiators can structure the (C) component separately or in combination of them.

The content of (C) component in the composition of the present invention is normally in a range from 0.1 to 10% by mass to the total quantity of the composition, preferably in a range from 0.2 to 5% by mass, and more preferably from 1 to 5% by mass. If the content of (C) component is less than 0.1% by mass, the radiation curing property of the obtained resin composition deteriorates, thus failing to model a three-dimensional shape object having sufficient mechanical strength. If the content thereof exceeds 10% by mass, when the obtained resin composition is used in the optical three-dimensional modeling method, appropriate light transmissivity cannot be attained, which results in difficulty in controlling the curing depth, and likely deteriorates the modeling accuracy of the obtained three-dimensional shape object.

The (D) Component

The (D) component used in the composition of the present invention is a radical polymerizable compound. Specifically, the compound is a compound having ethylenic unsaturated bond (C═C), and examples of that kind of compound are a monofunctional monomer having one ethylenic unsaturated bond in a single molecule, and a polyfunctional monomer having two or more ethylenic unsaturated bonds in a single molecule.

The monofunctional monomer and the polyfunctional monomer can structure the (D) component separately or in combination of two or more of them, or in combination of at least one monofunctional monomer with at least one polyfunctional monomer.

It is preferable that the (D) component contains 60% by mass or more of tri- or higher functional monomer, i.e. a polyfunctional monomer having three or more of ethylenic unsaturated bonds in a single molecule, to 100% by mass of (or the total quantity of) the (D) component. Further preferable content of the tri- or higher functional monomer is 70% by mass or more, more preferable content is 80% by mass or more, and most preferable content is 100% by mass. If the content of polyfunctional monomer, (tri- or higher functional monomer), is 60% by mass or more, the radiation curing property of the obtained resin composition further improves, and the time-change of the modeled three-dimensional shape object likely becomes small.

Examples of the monofunctional monomer of the (D) component are compounds such as acrylamide, (meth)acryloyl morpholine, 7-amino-3,7-dimethyloctyl(meth)acrylate, isobutoxymethyl(meth)acrylamide, isobornyloxyethyl(meth)acrylate, isobornyl(meth)acrylate, 2-ethylhexyl(meth)acrylate, ethyldiethyleneglycol(meth)acrylate, t-octyl(meth)acrylamide, diacetone(meth)acrylamide, dimethylaminoethyl(meth)acrylate, diethylaminoethyl(meth)acrylate, lauryl(meth)acrylate, dicyclopentadiene(meth)acrylate, dicyclopentenyloxyethyl(meth)acrylate, dicyclopentenyl(meth)acrylate, N,N-dimethyl(meth)acrylamidetetrachlorophenyl(meth)acrylate, 2-tetrachlorophenoxyethyl(meth)acrylate, tetrahydrofulfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, butoxyethyl(meth)acrylate, pentachlorophenyl(meth)acrylate, pentabromophenyl(meth)acrylate, polyethyleneglycolmono(meth)acrylate, polypropyleneglycolmono(meth)acrylate, bornyl(meth)acrylate, and methyltriethylenediglycol(meth)acrylate.

Examples of the polyfunctional monomer of the (D) component are ethyleneglycoldi(meth)acrylate, dicyclopentenyldi(meth)acrylate, triethyleneglycoldiacrylate, tetraethyleneglycoldi(meth)acrylate, tricyclodecanediyldimethylenedi(meth)acrylate, tris(2-hydroxyethyl)isocyanuratedi(meth)acrylate, tris(2-hydroxyethyl)isocyanuratetri(meth)acrylate, caprolactone modified tris(2-hydroxyethyl)isocyanuratetri(meth)acrylate, trimethylolpropanetri(meth)acrylate, ethylene oxide, (hereinafter referred to as EO), modified trimethylolpropanetri(meth)acrylate, propylene oxide, (hereinafter referred to as PO), modified trimethylolpropanetri(meth)acrylate, tripropyleneglycoldi(meth)acrylate, neopentylglycoldi(meth)acrylate, (meth)acrylic acid additive on both terminals of bisphenol A diglycidylether, 1,4-butanedioldi(meth)acrylate, 1,6-hexanedioldi(meth)acrylate, pentaerythritoltri(meth)acrylate, pentaerithritoltetra(meth)acrylate, polyesterdi(meth)acrylate, polyethyleneglycoldi(meth)acrylate, dipentaerithritolhexa(meth)acrylate, dipentaerithritolpenta(meth)acrylate, dipentaerithritoltetra(meth)acrylate, caprolactone modified dipentaerithritolhexa(meth)acrylate, caprolactone modified dipentaerithritolpenta(meth)acrylate, ditrimethylolpropanetetra(meth)acrylate, EO modified bisphenol A di(meth)acrylate, PO modified bisphenol A di(meth)acrylate, EO modified hydrogenated bisphenol A di(meth)acrylate, PO modified hydrogenated bisphenol A di(meth)acrylate, EO modified bisphenol F di(meth)acrylate, and (meth)acrylate of phenol novolak polyglycidylether.

Of these, specifically preferred ones are those corresponding to the tri- or higher functional monomer, such as tri(meth)acrylate compound, tetra(meth)acrylate compound, penta(meth)acrylate compound, and hexa(meth)acrylate compound, and particularly preferred ones are tris(acryloyloxyethyl)isocyanurate, trimethylolpropanetri(meth)acrylate, EO modified trimethylolpropanetri(meth)acrylate, dipentaerithritolhexa(meth)acrylate, dipentaerithritolpenta(meth)acrylate, and ditrimethylolpropanetetra(meth)acrylate, which are exemplified above.

Examples of commercially available monofunctional monomer in the (D) component are Aronix M-101, M-102, M-111, M-113, M-117, M-152, and TO-1210, (manufactured by TOA GOSEI CO., LTD.), KAYARAD TC-110S, R-564, and R-128H, (manufactured by NIPPON KAYAKU CO., LTD.), Biscoat 192, Biscoat 220, Biscoat 2311HP, Biscoat 2000, Biscoat 2100,Biscoat 2150, Biscoat 8F, and Biscoat 17F, (manufactured by Osaka Organic Chemical Industry Ltd.).

Examples of commercially available polyfunctional monomer in the (D) component are SA 1002 (manufactured by Mitsubishi Chemical Corporation), Biscoat 195, Biscoat 230, Biscoat 260, Biscoat 215, Biscoat 310, Biscoat 214HP, Biscoat 295, Biscoat 300, Biscoat 360, Biscoat GPT, Biscoat 400, Biscoat 700, Biscoat 540, Biscoat 3000, and Biscoat 3700, (manufactured by Osaka Organic Chemical Industry Ltd.), KARAYAD R-526, HDDA, NPGDA, TPGDA, MANDA, R-551, R-712, R-604, R-684, PET-30, GPO-303, TMPTA, THE-330, DPHA, DPHA-2H, DPHA-2C, DPHA-21, D-310, D-330, DPCA-20, DPCA-30, DPCA-60, DPCA-120, DN-0075, DN-2475, T-1420, T-2020, T-2040, TPA-320, TPA-330, RP-1040, RP-2040, R-011, R-300, and R-205, (manufactured by NIPPON KAYAKU CO., LTD.), Aronix M-210, M-220, M-233, M-240, M-215, M-305, M-309, M-310, M-315, M-325, M-400, M-6200, and M-6400, (manufactured by TOA GOSEI CO., LTD.), Light Acrylate BP-4EA, BP-4PA, BP-2EA, BP-2PA, and DCP-A, (manufactured by KYOEISHA CHEMICAL CO., LTD.), New Frontier BPE-4, BR-42M, and GX-8345, (manufactured by DAI-ICHI KOGYO SEIYAKU Co., LTD.), ASF-400 (manufactured by Nippon Steel Chemical Co, Ltd.), Lipoxy SP-1506, SP-1507, SP-1509, VR-77, SP-4010, and SP-4060, (manufactured by SHOWA HIGHPOLYMER CO., LTD.), and NK Ester A-BPE-4 (manufactured by Shin-Nakamura Chemical Co., Ltd.).

The content of (D) component in the composition of the present invention is normally in a range from 0.1 to 25% by mass to the total quantity of the composition, and preferably in a range from 0.1 to 15% by mass. By the addition of the (D) component, the obtained resin composition improves the radiation curing property, and the time-change of the modeled three-dimensional shape object likely becomes small. If the content thereof exceeds 25% by mass, the impact resistance and the breaking toughness of the three-dimensional shape object deteriorate, which is unfavorable.

The (E) Component

The (E) component used in the composition of the present invention is a radical polymerization initiator, and is a compound which decomposes under irradiation of light and the like to generate radical, which radical then initiates the radical polymerization of the (D) component.

Examples of the (E) radical polymerization initiator are, acetophenone, acetophenonebenzylketal, anthraquinone, 1-(4-isopropylphenyl)-2-hydroxy-2-methylpropane-1-one, carbazole, xanthone, 4-chlorobenzophenone, 4,4′-diaminobenzophenone, 1,1-dimethoxydeoxybenzoin, 3,3′-dimethyl-4-methoxybenzophenone, thioxanthone-based compound, 2-methyl-1-[4-(methylthio)phenyl]-2-morphorino-propane-2-one, 2-benzyl-2-dimethylamino-1-(4-morphorinophenyl)-butane-1-one, triphenylamine, 2,4,6-trimethylbenzoyldiphenylphosphine oxide, bis(2,6-dimethoxybenzoyl)-2,4,4-tri-methylpentylphosphine oxide, benzyldimethylketal, 1-hydroxycyclohexylphenylketone, 2-hydroxy-2-methyl-1-phenylpropane-1-one, fluorenone, fluorene, benzaldehyde, bebzomethylether, benzoinpropylether, benzophenone, Michler's ketone, 3-methylacetophenone, 3,3′,4,4′-tetra(t-butylperoxycarbonyl)benzophenone (BTTB), and a combination of BTTB with pigment sensitizer such as xanthene, thioxanthene, coumalin, and ketocoumalin. Of these, specifically preferred ones are benzyldimethylketal, 1-hydroxycyclohexylphenylketone, 2,4,6-trimethylbenzoyldiphenylphosphine oxide, and 2-benzyl-2-dimethylamino-1-(4-morphorinophenyl)-butane-1-one. The above radical polymerization initiators can structure the (E) component separately or in combination with two or more of them.

The content of (E) component in the composition of the present invention is normally in a range from 0.01 to 10% by mass to the total quantity of the composition, and preferably in a range from 0.1 to 5% by mass. If the content of (E) component is less than 0.01% by mass, the obtained resin composition gives slow radical polymerization rate (curing rate) to take a time for modeling, and likely deteriorates the resolution. If the content thereof exceeds 10% by mass, the excess quantity of polymerization initiator deteriorates the curing characteristics of the resin composition, and may adversely affect the anti-humidification and heat resistance of the three-dimensional shape object.

The (F) Component

The (F) component used in the composition of the present invention is polyether polyol. With the addition of (F) component, the radiation curing property of the resin composition is improved, and the mechanical characteristics, specifically the elastic modulus, of the cured product obtained by irradiating light to the composition of the present invention is improved, thus suppressing the time-change of the shape and the mechanical characteristics of the three-dimensional modeled article obtained by the optical modeling.

A preferred (F) polyether polyol is the one having three or more hydroxyl groups in a single molecule, and specifically preferred one has three to six hydroxyl groups in a single molecule. By using a polyether polyol having three or more hydroxyl groups in a single molecule, satisfactory improving effect of radiation curing property is attained, and there likely appears a tendency of stabilizing the mechanical characteristics, specifically elastic modulus, of the obtained three-dimensional shape object.

Examples of the (F) polyether polyol are the ones prepared by modifying a polyhydric alcohol of tri- or higher valence, such as trimethylolpropane, glycerin, pentaerythritol, sorbitol, sucrose, and quadrol by a cyclic ether compound such as ethylene oxide (EO), propylene oxide (PO), butylene oxide, and tetrahydrofuran. Specific examples are EO modified trimethylolpropane, PO modified trimethylolpropane, tetrahydrofuran modified trimethylol propane, EO modified glycerin, PO modified glycerin, tetrahydrofuran modified glycerin, EO modified pentaerythritol, PO modified pentaerythritol, tetrahydrofuran modified pentaerythritol, EO modified sorbitol, PO modified sorbitol, EO modified sucrose, PO modified sucrose, and EO modified quodol. The above polyether polyols can structure the (F) component separately or in combination of two or more of them.

Examples of commercially available (F) polyether polyol are Sunnix TP-400, Sunnix GP-600, Sunnix GP-1000, Sunnix SP-750, Sunnix GP-250, Sunnix GP-400, and Sunnix GP-600, (manufactured by Sanyo Chemical Industries, Ltd.), TMP-3Glycol, PNT-4 Glycol, EDA-P-4, and EDA-P-8, (manufactured by Nippon Nyukazai Co., Ltd.), G-300, G-400, G-700, T-400, EDP-450, SP-600, and SC-800, (manufactured by ADECA Corporation), SCP-400, SCP-1000, and SP-1600, (manufactured by Sakamoto Yakuhin Kogyo Co., Ltd.).

The content of (F) component in the composition of the present invention is normally in a range from 1 to 35% by mass to the total quantity of the composition, preferably in a range from 1 to 25% by mass, and more preferably from 3 to 15% by mass. If the content of (F) component is less than 1% by mass, the resin composition deteriorates in the delayed curing property, thus fails to sufficiently attain the effect of improving the radiation curing property, and in some cases, fails to obtain a three-dimensional shape object having good shape-stability and property-stability. On the other hand, if the content of (F) component exceeds 35% by mass, also the obtained resin composition deteriorates in the radiation curing property, and likely decreases the elastic modulus of the three-dimensional shape object formed by the optical modeling.

The (G) Component

The (G) component used in the composition of the present invention is elastomer particles having 10 to 1000 nm of number-average particle size determined by the electron microscope method. With the addition of (G) component, the cured article prepared by irradiating light to the composition of the present invention improves the impact resistance and the breaking toughness.

Examples of the (G) elastomer particles having 10 to 1000 nm of number-average particle size are the ones with the base component of polybutadiene, polyisoprene, butadiene-acrylonitrile copolymer, styrene-butadiene copolymer, styrene-isoprene copolymer, ethylene-propylene copolymer, ethylene-α-olefin copolymer, ethylene-α-olefin-polyene copolymer, acryl rubber, butadiene-(meth)acrylate copolymer, styrene-butadiene block copolymer, and styrene-isoprene block copolymer. The (G) elastomer particles having 10 to 1000 nm of number-average particle size may also be core/shell type particles. Of these elastomer particles, specifically preferred ones are prepared by covering a core prepared by partially cross-linking polybutadiene, polyisoprene, styrene-butadiene copolymer, styrene-isoprene copolymer, butadiene-(meth) acrylate copolymer, styrene-butadiene block copolymer, styrene-isoprene block copolymer, and the like with methylmethacrylate polymer or with methylmethacrylate-glycidylmethacrylate copolymer.

Of these (G) components, there are commercially available above core/shell type elastomer particles, including Resinous Bond RKB (manufactured by Resinous Chemicals, Ltd.) and Techno MBS-61 and MBS-69, (manufactured by Techno Polymer Co., Ltd.).

The content of (G) component in the composition of the present invention is normally in a range from 1 to 35% by mass to the total quantity of the composition, preferably in a range from 2 to 20% by mass, and more preferably from 3 to 15% by mass. If the content of (G) component is less than 1% by mass, the impact resistance and the breaking toughness deteriorate. On the other hand, if the content of (G) component exceeds 35% by mass, the viscosity increases to generate bubbles during modeling, and likely deteriorates the modeling accuracy of the obtained three-dimensional shape object.

The radiation curing liquid resin composition according to the present invention may further contain a photo-sensitizer (polymerization accelerator), reactive diluent, and the like. Examples of the photo-sensitizer are: amine-based compound such as triethanolamine, methyldiethanolamine, triethylamine, and diethylamine; thioxanthone; a derivative of thioxanthone; anthraquinone; a derivative of anthraquinone; anthracene; a derivative of anthracene; perylene; a derivative of perylene; benzophenone; and benzoin isopropylether.

Furthermore, the radiation curing liquid resin composition for optical modeling according to the present invention may further contain various additives as other arbitrary components within a range not adversely affecting the object and the effect of the present invention. Examples of these other additives are: polymer or oligomer such as polyamide, polyamideimide, polyurethane, polybutadiene, polychloroprene, polyester, styrene-butadiene block copolymer, petroleum resin, xylene resin, ketone resin, cellulose resin, fluorine-based oligomer, silicone-based oligomer, and polysulfide-based oligomer; polymerization inhibitor such as phenothyazine and 2,6-di-t-butyl-4-methylphenol; polymerization initiator assistant; leveling agent; wettability improving agent; surface active agent; plasticizer; ultraviolet light absorber; silane coupling agent; inorganic filler; pigment; and dye. The radiation curing liquid resin composition according to the present invention can be manufactured by uniformly mixing the above components of (A) through (G), and, if needed, above arbitrary components. The viscosity of thus obtained radiation curing liquid resin composition is preferably in a range from 10 to 20,000 cps (25° C.), more preferably from 50 to 10,000 cps, and most preferably from 50 to 5,000 cps.

The method for manufacturing the composition of the present invention is described in the following. The composition of the present invention can be manufactured by charging adequate quantity of the above respective components (A) through (G), and other additives to an agitation vessel, and by agitating the contents at temperatures of normally in a range from 30° C. to 70° C., preferably from 50° C. to 60° C., for a period of normally 1 to 6 hours, preferably 1 to 2 hours.

The composition of the present invention provides an optically modeled article having small step on the side face, excellent surface smoothness, at high accuracy.

II. Optically Modeled Article

The optically modeled article according to the present invention is characterized in that it can be obtained by irradiating light to the composition of the present invention.

The radiation curing liquid resin composition according to the present invention obtained by the above procedure is suitably used as the radiation curing liquid resin composition for the optical three-dimensional modeling method. That is, the three-dimensional shape object of a desired shape can be manufactured by the optical three-dimensional modeling method that selectively irradiating light such as visible light, ultraviolet light, and infrared light to the radiation curing liquid resin composition according to the present invention, thus to supply energy necessary for curing the composition.

The means to selectively irradiate light to the radiation curing liquid resin composition is not specifically limited, and varieties of means can be applied. Examples of the means are: the one that irradiates light such as laser light or a light converged by a lens or a mirror to the composition while scanning the light; the one that uses a mask which has a light transmitting section to allow a specific light pattern to pass through, thus irradiating the non-converged light to the composition via the mask; and the one that uses a light-guide member fabricated by bundling pluralities of optical fibers which respond to a specified light pattern, thus irradiating the light to the composition via the light-guide. For the means that uses a mask, it is possible to electro-optically form a mask image composed of the light-transmitting zone and the light-nontransmitting zone under a specified pattern utilizing the same principle as that of the liquid crystal display apparatus. Regarding the above means, if the target three-dimensional shape object has a fine portion or is requested to have high dimensional accuracy, the means to selectively irradiate light to the composition is preferably a means that scans laser light having small spot-diameter. The plane of light irradiation (such as scanning plane of converged light) on the resin composition held in a vessel is any of the liquid surface of the resin composition and the contact plane with the wall of the light transmitting vessel. When the liquid surface of the resin composition or the contact plane with the wall of the vessel is adopted as the irradiation plane of light, light can be irradiated from outside the vessel directly or via the vessel wall.

According to the above-described optical three-dimensional modeling method, normally a specified portion of the resin composition is cured, and then the light-irradiating position (irradiating plane) is moved continuously or stepwise from the cured portion to the non-cured portion, thus laminating the cured portions to form the desired three-dimensional shape. The movement of the irradiating position can be done by varieties of methods, such as: moving any of the light source, the vessel holding the resin composition, and the cured portion of the resin composition; and successively charging the resin composition to the vessel. Following description is a typical example of the above optical three-dimensional modeling method. A supporting stage located in the vessel in an ascending/descending mode is lowered (immersed) to a slight depth below the liquid surface of the resin composition, thus charging the resin composition onto the supporting stage to form the thin layer (1) of the resin composition. Then, light is selectively irradiated to the thin layer (1) to form the solid state cured resin layer (1). Subsequently, the radiation curing liquid resin composition is charged onto the cured resin layer (1) to form the thin layer (2) of the composition. Light is selectively irradiated to the thin layer (2), thus forming the new cured resin layer (2) on the cured resin layer (1) so as to continuously and integrally laminate together. Then, by repeating the steps for a specified number of cycles while varying or not varying the pattern of light irradiation, a three-dimensional shape object having integrally-laminated cured resin layers (n) is modeled.

Thus obtained three-dimensional shape object is taken out from the vessel. After removing the non-reacted resin composition left on the surface of the shape object, cleaning is applied as needed. Examples of cleaning agent are: alcohol-based organic solvent represented by alcohols such as isopropyl alcohol and ethyl alcohol; ketone-based organic solvent such as acetone, ethylacetate, and methylethylketone; aliphatic organic solvent represented by terpenes; and low viscosity thermosetting resin and radiation curing resin. Incidentally, to manufacture a three-dimensional shape object having good surface smoothness, it is preferable to conduct cleaning using the above thermosetting resin or the radiation curing resin. In this case, it is necessary to conduct post-curing by heat irradiation or light irradiation depending on the kind of curing resin used for the cleaning. Since post-curing not only cures the surface of the resin but also cures the non-reacted resin composition remained in the three-dimensional shape object, the post-curing is preferably conducted also for the case of cleaning with organic solvent.

The optically modeled article according to the present invention has high accuracy, small step on the side face, and excellent surface smoothness.

### EXAMPLES

The present invention is described in more detail in the following referring to the examples. However, the present invention is not limited by these examples.

[Preparation of Liquid Resin Composition]

The respective components were charged to an agitation vessel at the respective blending rates given in Table 1. The contents were agitated at 60° C. for 3 hours, and thus obtained were the respective liquid resin compositions of Examples 1 to 8 and Comparative Examples 1 to 6. The blending rate is expressed by mass %.

With the respective liquid resin compositions of Examples 1 to 8 and Comparative Examples 1 to 6, the evaluation test was given in terms of delayed curing property and the step on the side face of the modeled article. The results are given in Table 1.

Evaluation Methods

[Delayed curing property] For each resin liquid, the line image was formed using the Laser Modeling Machine SCS-300P (D-MEC Ltd.): (A single cured line was prepared by drawing a single cycle of 4 cm in length applying a laser power of 100 mW on the irradiation plane (liquid surface) under the condition of about 70 mJ/cm² of irradiation amount of light giving 160 μm of curing width at 870 mm/sec of scanning rate). Immediately after the irradiation and at 20 minutes after the irradiation, respectively, the cured product in a line-shape was taken out from the resin liquid to determine the cured width and the cured depth using an optical microscope. Then the increased quantity of the cured depth, (D₂₀−D₀), was calculated, where D₀ signifies the cured depth immediately after the irradiation, and D₂₀ signifies the cured depth at 20 minutes after the irradiation. When the increase in the cured depth was 40 μm or more, the evaluation was given as ∘, when the cured depth was between 20 and 40 μm, the evaluation was given as Δ, and when the cured depth was 20 μm or less, the evaluation was given as x.

[Step on the Side Face of the Modeled Article (μm)]

A sample for evaluation was modeled using the Solid Creator SCS-300P (manufactured by Sony Manufacturing Systems Corporation) by repeating the step of selectively irradiating laser light to the radiation curing resin composition to form a cured resin layer (0.10 mm in thickness) under the condition of scanning speed of 100 mW of laser power on the irradiating plane (liquid surface) to give 0.2 mm of cured depth for each composition. Then, the sample was taken out from the Solid Creator, and the resin composition adhered on the outer surface of the sample washed to remove. The sample was allowed standing in a room with constant temperature and humidity at 23° C. and 50% RH for 24 hours, and then measured. The step on the side face was measured by determining the irregular portion (step) on the side face of the modeled article using a laser microscope (OPTIPHOT-POL, manufactured by Nikon Corporation).

TABLE 1

| | | Example | | | | | | | |
|---|---|---|---|---|---|---|---|---|---|
| Component | Composition (mass %) | 1 | 2 | 3 | 4 | 5 | 6 | 7 | 8 |
| A | Irganox 1010 | 1.15 | — | — | — | — | — | — | 1.27 |
| | Irganox 1520L | — | 2.28 | 3.38 | — | — | — | — | — |
| | Irganox 245 | — | — | — | 2.28 | 3.38 | — | — | — |
| | Irgafos 38 | — | — | — | — | — | 1.15 | — | — |
| | sumilizer GP | — | — | — | — | — | — | 1.15 | |
| B | 3,4-Epoxy cyclohexyl methyl- | 23.1 | 22.8 | 22.6 | 22.8 | 22.6 | 23.1 | 23.1 | 25.4 |
| | 3′,4′-epoxycyclohexylcarboxylate | | | | | | | | |
| | Bis (3,4-epoxycyclohexylmethyl) adipate | 27.7 | 27.4 | 27.1 | 27.4 | 27.1 | 27.7 | 27.7 | 30.5 |
| | BisphenolAdiglycidylether | 8.3 | 8.2 | 8.1 | 8.2 | 8.1 | 8.3 | 8.3 | 9.2 |
| | 1,6-Hexanediol diglycidylether | 3.7 | 3.7 | 3.6 | 3.7 | 3.6 | 3.7 | 3.7 | 4.1 |
| C | CPI6976 | 4.6 | 4.6 | 4.5 | 4.6 | 4.5 | 4.6 | 4.6 | 5.1 |
| D | Tris (acryloyloxyethyl) isocyanurate | 12.0 | 11.9 | 11.7 | 11.9 | 11.7 | 12.0 | 12.0 | 13.2 |
| E | 1-Hydroxycyclohexylphenylketone | 1.8 | 1.8 | 1.8 | 1.8 | 1.8 | 1.8 | 1.8 | 2.0 |
| F | PO modified trimethylolpropane | 8.3 | 8.2 | 8.1 | 8.2 | 8.1 | 8.3 | 8.3 | 9.2 |
| G | Elastomer particles | 9.2 | 9.1 | 9.0 | 9.1 | 9.0 | 9.2 | 9.2 | — |
| Total | | 100 | 100 | 100 | 100 | 100 | 100 | 100 | 100 |
| Evaluation | Delayed curing property | ∘ | ∘ | ∘ | ∘ | ∘ | ∘ | ∘ | ∘ |
| | Step on the side face of modeled article (μm) | 5 | 6 | 6 | 6 | 6 | 6 | 6 | 5 |

| | | Comparative Example | | | | | |
|---|---|---|---|---|---|---|---|
| Component | Composition (mass %) | 1 | 2 | 3 | 4 | 5 | 6 |
| A | Irganox 1010 | — | 1.15 | 1.31 | 0.0005 | 12.30 | — |
| | Irganox 1520L | — | — | — | — | — | 2.28 |
| | Irganox 245 | — | — | — | — | — | — |
| | Irgafos 38 | — | — | — | — | — | — |
| | sumilizer GP | — | — | — | — | — | — |
| B | 3,4-Epoxy cyclohexyl methyl- | 23.4 | | 26.23 | 23.4 | 20.5 | 22.8 |
| | 3′,4′-epoxycyclohexylcarboxylate | | | | | | |
| | Bis (3,4-epoxycyclohexylmethyl) adipate | 28.0 | — | 31.48 | 28.0 | 24.6 | 27.4 |
| | BisphenolAdiglycidylether | 8.4 | — | 9.44 | 8.4 | 7.4 | 8.2 |
| | 1,6-Hexanediol diglycidylether | 3.7 | — | 4.20 | 3.7 | 3.3 | 3.7 |
| C | CPI6976 | 4.7 | 4.6 | 5.25 | 4.7 | 4.1 | 4.6 |
| D | Tris (acryloyloxyethyl) isocyanurate | 12.1 | 74.8 | — | 12.1 | 10.7 | 11.9 |
| E | 1-Hydroxycyclohexylphenylketone | 1.9 | 1.8 | 2.10 | 1.9 | 1.6 | 1.8 |
| F | PO modified trimethylolpropane | 8.4 | 8.3 | 9.44 | 8.4 | 7.4 | — |
| G | Elastomer particles | 9.3 | 9.2 | 10.49 | 9.3 | 8.2 | 9.1 |
| Total | | 100 | 100 | 100 | 100 | 100 | 100 |
| Evaluation | Delayed curing property | x | x | x | x | x | x |
| | Step on the side face of modeled article (μm) | 12 | 14 | 16 | 15 | 16 | 16 |

Irganox 1010: pentaerythrityl-tetrakis [3-(3,5-di-t-butyl-4-hydroxyphenyl)propionate] (manufactured by Ciba Specialty Chemicals K.K.)

Irganox 1520L: 4,6-bis(octylthiomethyl)-o-cresol (manufactured by Ciba Specialty Chemicals K.K.)

Irganox 245: triethyleneglycol-bis[3-(3-t-butyl-5-methyl-4-hydroxyphenyl)propionate] (manufactured by Ciba Specialty Chemicals K.K.)

Irganox 38: bis[2,4-bis(1,1-dimethylethyl)-6-methylphenyl]ethyl phosphite (manufactured by Ciba Specialty Chemicals K.K.)

Sumilizer GP: 6-[3-(3-t-butyl-4-hydroxy-5-methylphenyl)propoxy]-2,4,8,10-tetra-t-b utyldibenz[d,f][1,3,2]-dioxaphosphepin (manufactured by Sumitomo Chemical Co., Ltd.)

CPI-6967: mixture of (1) diphenyl (phenylthiophenyl) sulfoniumhexafluoroantimonate and (2) bis[4-(diphenylsulfonio) phenyl]sulfidebishexafluoroantimonate (manufactured by Aceto Corporation)

Elastomer particles (Resinous bond RKB, manufactured by Resinous Chemicals, Ltd.)

### INDUSTRIAL APPLICABILITY

The composition of the present invention is suitably used in the optical three-dimensional modeling.

The composition of the present invention is suitably used in the applications that require further high accuracy of three-dimensional modeling, specifically require improvement in surface smoothness caused by the step on the side face between each of laminated layers on the modeled article.

1-5. (canceled)

6. A radiation curing liquid resin composition for optical three-dimensional modeling, comprising the components (A) through (F), the content of (A) component in the total quantity of the composition being 0.1 to 10% by mass, and the content of (F) polyether polyol compound being 1 to 35% by mass:
(A) a compound having phenolic hydroxyl group and/or phosphite group,
(B) a cationic polymerizable compound,
(C) a cationic polymerization initiator,
(D) a radical polymerizable compound,
(E) a radical polymerization initiator, and
(F) a polyether polyol compound.

7. The radiation curing liquid resin composition for optical three-dimensional modeling according to claim 6, wherein the content of each of (B) component through (E) component in the total quantity of the composition is:
15 to 85% by mass of (B) the cationic polymerizable compound,
0.1 to 10% by mass of (C) the cationic polymerization initiator,
0.1 to 25% by mass of (D) the radical polymerizable compound, and
0.01 to 10% by mass of (E) the radical polymerization initiator.

8. The radiation curing liquid resin composition for optical three-dimensional modeling according to claim 6, further comprising (G) elastomer particles having a number-average particle size determined by the electron microscope method in a range from 10 to 1000 nm in a quantity of 1 to 35% by mass to the total quantity of the composition.

9. The radiation curing liquid resin composition for optical three-dimensional modeling according to claim 6, wherein (A) the compound having phenolic hydroxyl group and/or phosphite group is at least one compound selected from the group consisting of compounds represented by the formula (1), the formula (2), and the 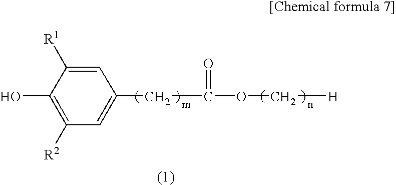
where R¹ and R² are each independently C1 to C4 alkyl group which may have a branched structure, and m and n are each independently 1 or 2; 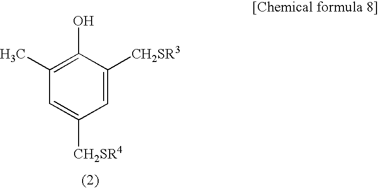
where R³ and R⁴ are each independently C6 to C₁₀ alkyl group which may have a branched structure; and 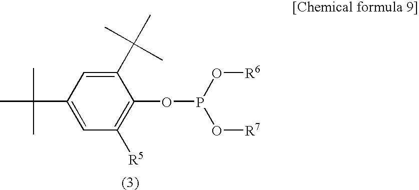
where R⁵ is a hydrogen or a methyl group, R⁶ and R⁷ are each independently an organic group, and R⁶ and R⁷ may bond together to form a cyclic structure.

10. An optically modeled article being manufactured by irradiating light to the radiation curing liquid resin composition for optical three-dimensional modeling according to claim 6.

11. An optically modeled article being manufactured by irradiating light to the radiation curing liquid resin composition for optical three-dimensional modeling according to claim 7.

12. An optically modeled article being manufactured by irradiating light to the radiation curing liquid resin composition for optical three-dimensional modeling according to claim 8.

13. An optically modeled article being manufactured by irradiating light to the radiation curing liquid resin composition for optical three-dimensional modeling according to claim 9.
